(19) United States
(12) Patent Application Publication
(10) Pub. No.: US 2006/0251061 A1
(43) Pub. Date: Nov. 9, 2006

(54) Apparatus for detecting symbol in SDM system and method thereof

(75) Inventors: Jaeseok Kim, Seoul (KR); Yunho Jung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: YONSEI UNIVERSITY

(21) Appl. No.: 11/136,402

(22) Filed: May 25, 2005

(30) Foreign Application Priority Data
Apr. 13, 2005 (KR) 10-2005-0030836

(51) Int. Cl. H04Q 11/00

(52) U.S. Cl. 370/366

(57) ABSTRACT

An apparatus for detecting a symbol in a space division multiplexing system and a method thereof are disclosed. The apparatus includes: a QR decomposing unit for performing a QR decomposition on a channel matrix H to decompose the channel matrix H to a Q matrix and a R matrix; a first symbol detecting unit for detecting a first symbol from a receive signal vector by using the result of the QR decomposition; a candidate symbol deciding unit for deciding the detected first symbol and Nc−1 symbols adjacent to the detected first symbol on a constellation as candidate symbols, wherein the Nc is an positive integer number; a candidate vector detecting unit for detecting Nc candidate transmit symbol vectors from the detected Nc candidate symbols; and a transmit symbol vector deciding unit for deciding an optimized transmit symbol vector among the detected Nc candidate transmit symbol vectors.

### FIELD OF THE INVENTION

The present invention relates to an apparatus for detecting a symbol and a method thereof and, more particularly, to an apparatus for rapidly and precisely detecting a symbol in a receiver of a space division multiplexing (SDM) system.

### DESCRIPTION OF RELATED ARTS

A wireless communication service is transited from a low speed voice communication service to a high speed multimedia communication service. Accordingly, there is a growing interest in a high speed data communication service and there are many studies in progress for increasing data transmission rate. A space division multiplexing (SDM) scheme was introduced by G. J. Foschini in 1996. The SDM scheme dramatically increases the data transmission rate by using a multiple transmit/receive antennas. The SDM scheme may be called as a bell-labs layered space-time (BLAST). The SDM scheme splits a single user's data stream into multiple sub-streams and simultaneously transmits the multiple sub-streams in parallel through the multiple transmit antennas. Therefore, the data transmission rate of the SDM scheme increases in proportion to the number of the transmit antennas used.

Since the SDM scheme pursues a spatial multiplexing gain while a space-time code (STC) scheme pursues a spatial diversity gain, each of transmit antennas independently transmits symbols in the SDM scheme. Therefore, to detect transmitted symbols becomes a major scheme for a receiver in a SDM system.

FIG. 1 is a block diagram illustrating a SDM system using Nₜ transmit antennas and Nr receive antennas.

As shown in FIG. 1, the SDM system includes a serial-parallel converting unit 11, Nₜ transmit antennas, Nᵣ receive antennas, a symbol detecting unit 12 and a parallel-serial converting unit 13.

The serial-parallel converting unit 11 splits a data stream into Nₜ uncorrelated sub-streams and transmits the Nₜ uncorrelated sub-streams through the Nₜ transmit antennas. The transmitted Nₜ sub-streams are picked up by the Nᵣ receive antennas after being perturbed by a channel matrix H (assuming quasi-static).

The symbol detecting unit 12 detects symbols from the sub-streams received through the Nᵣ receive antennas.

The parallel-serial converting unit 13 converts the detected symbols, which are parallel data, to serial data.

If it assumes that a transmitting signal experiences a Rayleigh flat fading while traveling a narrowband wireless channel, a relation between a Nₜ-dimensional transmit signal vector and a Nᵣ-dimensional receive signal vector can be expressed as following Equation (1)
x=H·s+v (1)

where x denotes the Nᵣ-dimensional receive signal vector, s stands for the Nₜ-dimensional transmit signal vector, H represents the [Nᵣ×Nₜ]-dimensional complex channel matrix and v is an additive white Gaussian noise. H is assumed to be a constant during each symbol time and to be known to a receiver through channel training. Since the transmitting signal is assumed to experience the Rayleigh flat fading, each of elements of H is also assumed to be independently and identically distributed (i.i.d), to have a mean value of 0 and to have a variance of 1. As described above, v is an additive white Gaussian noise and has a mean value of 0. Accordingly, a covariance matrix of v can be represented as following Equation (2)
E[v·v^{•}]=δᵥ²·I_{N}_{ᵣ}, (2)
where the superscript * denotes the conjugate-transpose of a vector signal and I_{N}_{ᵣ} represents a Nᵣ-dimensional identity matrix.
The Nₜ-dimensional transmit signal vector s is assumed to have a mean value of 0 and a variance of δₛ², and the total power of s is assumed to be P. Thus, the covariance matrix of s is given by Equation (3) and a signal-to-noise ratio (SNR) is defined as Equation (4).

$$\begin{matrix}E [ s \cdot {s}^{*} ] = {δ}_{s}^{2} \cdot {I}_{{N}_{t}} = \frac{P}{{N}_{t}} \cdot {I}_{{N}_{t}} & ( 3 ) \\ ρ = \frac{{E}_{s}}{{N}_{0}} = \frac{{N}_{t} {δ}_{s}^{2} {δ}_{t}^{2}}{{δ}_{v}^{2}} = \frac{P}{{δ}_{v}^{2}} & ( 4 )\end{matrix}$$

In Equation (4), Eₛ and N₀ denote the signal energy and noise power spectral density, respectively.
Meanwhile, there are several optimized detection algorithms with reduced complexity introduced recently for effectively performing a SDM scheme. Among the introduced algorithms, a sorted QR decomposition (SQRD) algorithm is spotlighted as a good solution for real-time implementation. The SQRD algorithm detects symbols by a QR decomposition of a channel matrix H without calculating a series of pseudo inverse of the channel matrix. Hereinafter, a conventional method of detecting a transmit signal vector s from a receive signal vector x using QR decomposition will be explained in detail.
At first, the QR decomposition is performed on a channel matrix H for decomposing the channel matrix H to QR (H=Q·R). Accordingly, a unitary matrix Q and an upper-triangular matrix R having zero lower triangular are decomposed from the channel matrix H. If Q^{H} is multiplied to both sides by using a characteristic that the matrix Q is the unitary matrix, i.e., Q^{H}Q=I, where the superscript H denotes a conjugate transpose of a matrix and I represents an identity matrix, following Equation (5) can be obtained.

$$y = {Q}^{H} x = Rs + {Q}^{H} v = ( \begin{matrix}{r}_{1.1} & {r}_{1.2} & ⋯ & {r}_{1 … {N}_{t}} \\ 0 & {r}_{2.2} & ⋯ & {r}_{2 … {N}_{t}} \\ 0 & 0 & ⋯ & {r}_{{N}_{t} - 1 … {N}_{t}} \\ 0 & 0 & ⋯ & {r}_{{N}_{t} … {N}_{t}}\end{matrix} ) s + {Q}^{H} v \qquad ( 5 )$$

In Equation (5), y denotes a Nₜ-dimensional column vector.
A last term of the Equation (5) can be simplified to following Equation (6) if Q^{H}v=v′ is applied to the Equation (5).
y_{N}_{ₜ}=r_{N}_{_{t•}}_{N}_{ₜ}·S_{N}_{ₜ}÷V′_{N}_{ₜ} (6)
Since the Equation (6) is same to a result equation of a general communication system using single antenna, it is possible to detect a (Nt)th symbol by using the following Equation (7).

$$\hat{s} = Q ( \tilde{s} ) = Q ( \frac{{y}_{{N}_{t}}}{{r}_{{N}_{t} = {N}_{0}}} ) = Q ( {s}_{{N}_{t}} + \frac{{{v}^{′}}_{{N}_{t}}}{{r}_{{N}_{t} = {N}_{0}}} ) \qquad ( 7 )$$

In the Equation (7), Q( ) denotes a symbol decision calculation appropriate to a constellation of a transmitted symbol. If an influence of (Nt)th symbol detected through the Equation (7) is eliminated from (Nt−1)th term of the Equation (5), Equation (8) is obtained.
y′_{N}_{_{t−1}}=y_{N}_{ₜ}₋₁−r_{N}_{_{t−1}},_{N}_{ₜ}ŝ_{N}_{ₜ}=r_{N}_{_{t−1}},_{N}_{_{t−1}}S_{N}_{_{t−1}}+v′_{N}_{_{t−1}} (8)
The Equation (8) is also identical to a result equation of a general communication system having single antenna. Therefore, a (Nt−1)th symbol can be detected by identical method of the Equation (7) and the transmit symbol vector s can be detected by orderly applying the above describe method to remained terms of y.
However, a performance of the SQRD based algorithm may be degraded compared to a conventional ordered successive detection (OSD) algorithm because a detection order of the SQRD based algorithm is not always optimized while the OSD algorithm always provides optimized detection order. Especially, if an error is occurred from the first detected signal, the error is propagated while detecting following symbols. Therefore, the total system performance can be seriously degraded.

### SUMMARY OF THE INVENTION

It is, therefore, an object of the present invention to provide an apparatus for detecting a symbol in a SDM system to improve a total system performance by lowering an error probability of a first detected symbol in a receiver of a space division multiplexing (SDM) system, and a method thereof.

In accordance with an aspect of the present invention, there is provided an apparatus for detecting a symbol in a space division multiplexing (SDM) system including: a QR decomposing unit for performing a QR decomposition on a channel matrix H to decompose the channel matrix H to a Q matrix and a R matrix; a first symbol detecting unit for detecting a first symbol from a receive signal vector by using the result of the QR decomposition; a candidate symbol detecting unit for deciding the detected first symbol and Nc−1 symbols adjacent to the detected first symbol on a constellation as candidate symbols, wherein the Nc is an positive integer number; a candidate vector detecting unit for detecting Nc candidate transmit symbol vectors from the detected Nc candidate symbols; and a transmit symbol vector deciding unit for deciding an optimized transmit symbol vector among the detected Nc candidate transmit symbol vectors.

In accordance with another aspect of the present invention, there is provided a method of detecting a symbol in a space division multiplexing (SDM) system including: detecting a first symbol from a receive signal vector by performing a QR decomposition on the channel matrix H; deciding the detected first symbol and Nc−1 candidate symbols adjacent to the detected first symbol on a constellation as candidate symbols, wherein the Nc is an positive integer number; detecting Nc candidate transmit symbol vectors from the decided Nc candidate symbols as candidate symbol vectors; and deciding an optimized transmit symbol vector among the Nc candidate transmit symbol vector.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a SDM system using Nₜ transmit antennas and Nᵣ receive antennas;

FIG. 2 is a block diagram depicting an apparatus for detecting a symbol in a space division multiplexing (SDM) system in accordance with a preferred embodiment of the present invention;

FIG. 3 is a flowchart showing a method of detecting a symbol in accordance with a preferred embodiment of the present invention; and

FIG. 4 is a graph depicting a performance of a apparatus for detecting a symbol in a SDM system according to a preferred embodiment of the present invention.

### DETAILED DESCRIPTION OF THE INVENTION

Hereinafter, an apparatus for rapidly and precisely detecting a symbol in a receiver of a space division multiplexing (SDM) system in accordance with a preferred embodiment of the present invention will be described in more detail with reference to the accompanying drawings.

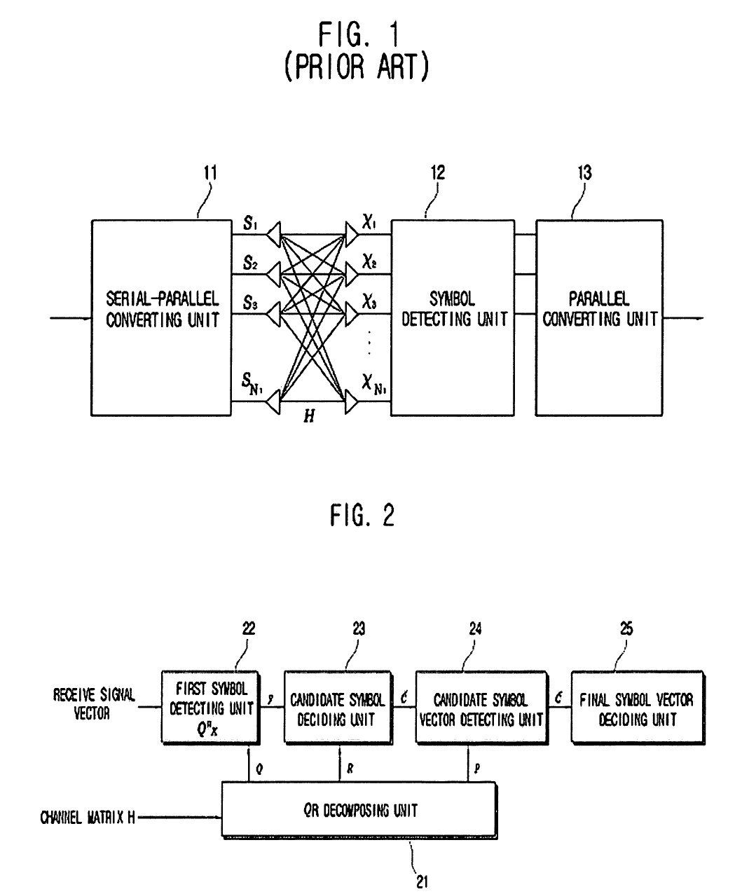

FIG. 2 is a block diagram illustrating an apparatus for detecting a symbol in a space division multiplexing (SDM) system in accordance with a preferred embodiment of the present invention.

As shown in FIG. 2, the apparatus for detecting s symbol in the SDM system includes a QR decomposing unit 21, a first symbol detecting unit 22, a candidate symbol deciding unit 23, a candidate symbol vector detecting unit 24, and a final symbol vector deciding unit 25.

The QR decomposing unit 21 performs a QR decomposition on a channel matrix H for decomposing the channel matrix H to a matrix Q and a matrix R.

The first symbol detecting unit 22 detects a first symbol from a receive signal vector by using a result of the QR decomposition from the QR decomposing unit 21.

The candidate symbol deciding unit 23 decides the first symbol detected from the first symbol detecting unit 22 and Nc−1 symbols adjacent to the detected first symbol on a constellation as candidate symbols. The Nc is a positive integer number.

The candidate symbol vector detecting unit 24 detects Nc candidate transmit signal vectors by orderly performing symbol detection through the Equation (8) on each of the Nc candidate symbols which are decided by the candidate symbol deciding unit 23. The symbol detection may be performed in parallel for each candidate transmit symbol vector.

The final symbol vector deciding unit 25 decides an optimized transmit symbol vector s by performing a maximum likelihood (ML) test on each of Nc candidate transmit symbol vectors detected from the candidate symbol vector detecting unit 24 based on following Equation (9). The ML test selects an input having a minimum squared Euclidean distance by substituting the Nc candidate transmit symbol vectors.
ŝ=arg min_{i=1, . . . ,N}_{ₜ}|x−H·ĉₜ|² (9)

As described above, the apparatus for detecting a symbol according to the present embodiment not only detects the first symbol but also detects Nc−1 symbols adjacent to the detected first symbol on a constellation in order to detect the Nc candidate symbols. The Nc candidate transmit symbol vectors are detected by applying the Equation (8) to the Nc candidate symbols and the ML test is performed over the Nc candidate transmit symbol vectors for finally deciding single transmit symbol vector for enhancing accuracy of the first detect signal.

In other word, the conventional QR decomposition based symbol detection method detects single symbol by using the Equations (6) and (7), and orderly applies the Equation (8) to detect other symbols for finally detecting single transmit symbol vector. However, a method of detecting a symbol according to the present embodiment detects Nc candidate transmit symbol vectors by using the Equations (6) and (7), and performs the ML test on each of Nc candidate transmit symbol vectors for deciding the final transmit symbol vector as an optimized vector.

Meanwhile, the present embodiment may be implemented to various QR decomposition based symbol detection algorithms such as a QR decomposition based symbol detection algorithm (QRD), a sorted QR decomposition based symbol detection algorithm (SQRD) and a QR decomposition symbol detection algorithm with minimum mean square error (MMSE) criterion.

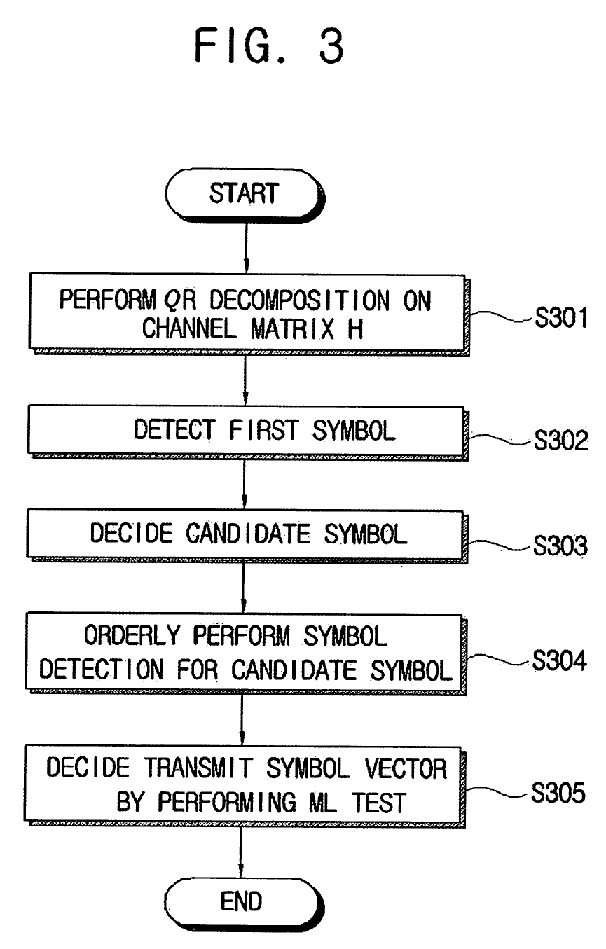

FIG. 3 is a flowchart showing a method of detecting a symbol in accordance with a preferred embodiment of the present invention.

Referring to FIG. 3, a QR decomposition is performed on a channel matrix H in operation S301. By using the result of the QR decomposition, a first symbol is detected from a receive signal vector in operation S302. The first detected symbol and Nc−1 symbols adjacent to the first detected symbol on a constellation are determined as candidate symbols in operation S303. Therefore, the total number of the candidate symbols decided in operation S303 is Nc by including the first detected symbol.

A symbol detection is orderly performed for the Nc candidate symbols in operation S304. In operation S304, total Nc candidate transmit symbol vectors are obtained. The symbol detection for the Nc candidate symbols may be performed in parallel for reducing processing time.

A ML test is performed over the Nc candidate transmit symbol vectors by using the Equation (9) for finally deciding a single transmit symbol vector s in operation S305.

Hereinafter, a performance of the apparatus for detecting a symbol in the SDM system according to the present embodiment will be compared to the same of the conventional apparatus for detecting a symbol.

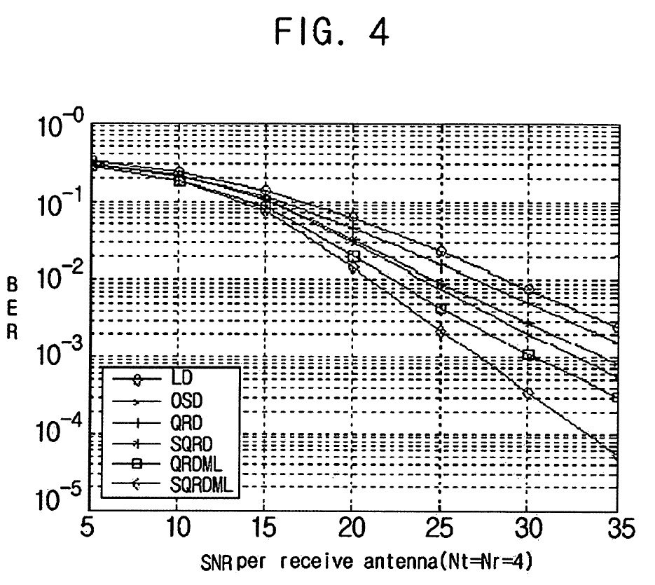

FIG. 4 is a graph depicting a performance of a apparatus for detecting a symbol in a SDM system according to a preferred embodiment of the present invention. The performance shown in FIG. 4 is obtained from a simulation under conditions of 4 transmit/receive antennas, 16 QAM modulation scheme and 4 candidate symbols (Nc=4).

In FIG. 4, a curve LD represents a performance of the simulation when a linear detection (LD) is applied, a curve OSD denotes a performance of the simulation when an ordered successive detection (OSD) is applied, a curve QRD is a performance of the simulation when a QR decomposition based detection is applied and a curve SQRD shows a performance of the simulation when a sorted QR decomposition based detection (SQRD) is applied. Furthermore, a curve QRDML and a curve SQRDML represent performances of the simulations when the method of detecting a symbol according to the present embodiment is applied. Especially, the curve QRDML shows a performance of the simulation when a QRD scheme with the ML test, which is one embodiment of the present invention, is applied and the curve SQRDML denotes a performance of the simulation when a SQRD scheme with the ML test, which is another embodiment of the present invention, is applied.

As shown in the graph of FIG. 4, the method of detecting a symbol according to the present embodiment has better performance than the LD scheme. That is, the method of detecting a symbol based on the QRD scheme with the ML test (QRDML) obtains about 9 dB of a signal-to-noise ratio (SNR) gain and the method of detecting a symbol based on the SQRD scheme with the ML test (SQRDML) obtains about 12 dB of the SNR gain compared to the conventional method using the LD scheme. Compared to the conventional symbol detection method using the QRD scheme, the symbol detection method using the QRDML obtains about 7 dB of the SNR gain and the symbol detection method using the SQRDML obtains about 10 dB of the SNR gain. Furthermore, compared to the conventional symbol detection method using the SQRD scheme, the symbol detection method using the QRDML obtains about 4.5 dB of the SNR gain and the symbol detection method using the SQRDML obtains about 7.5 dB of the SNR gain. Moreover, the symbol detection method based on the QRDML obtains about 3 dB of the SNR gain and the symbol detection method based on the SQRDML obtains about 6 dB of the SNR gain compared to the conventional symbol detection method using the OSD scheme.

As described above, the present embodiment decides a transmit symbol vector by detecting Nc candidate symbol vectors form Nc candidate symbols and performing the ML test on each of the detected Nc candidate symbol vectors in a receiver of a space division multiplexing (SDM) system. Therefore, accuracy of symbol detection is improved by lowering an error probability of the first detected symbol and a total performance of a system is also enhanced.

While the present invention has been particularly shown and described with reference to exemplary embodiments thereof, it will be understood by those of ordinary skilled in the art that various changes in form and details may be made therein without departing from the spirit and scope of the present invention as defined in the following claims.

What is claimed is:

1. An apparatus for detecting a symbol in a space division multiplexing (SDM) system, the apparatus comprising:
a QR decomposing unit for performing a QR decomposition on a channel matrix H to decompose the channel matrix H to a Q matrix and a R matrix
a first symbol detecting unit for detecting a first symbol from a receive signal vector by using the result of the QR decomposition;
a candidate symbol deciding unit for deciding the detected first symbol and Nc−1 symbols adjacent to the detected first symbol on a constellation as candidate symbols, wherein the Nc is an positive integer number;
a candidate symbol vector detecting unit for detecting Nc candidate transmit symbol vectors from the detected Nc candidate symbols; and
a final symbol vector deciding unit for deciding an optimized transmit symbol vector among the detected Nc candidate transmit symbol vectors.

2. The apparatus according to claim 1, wherein the QR decomposing unit decomposes the channel matrix to the Q matrix and the R matrix based on a sorted QR decomposition detection (SQRD) based algorithm.

3. The apparatus according to claim 1, wherein the candidate symbol vector detecting unit detects the candidate transmit symbol vectors in parallel on each of the Nc candidate symbols.

4. The apparatus according to claim 3, wherein the candidate symbol vector detecting unit performs a QR decomposition based symbol detection on each of the Nc candidate symbols determined in the candidate symbol deciding unit.

5. The apparatus according to claim 3, wherein the candidate symbol vector detecting unit performs a sorted QR decomposition based symbol detection on each of the Nc candidate symbols determined in the candidate symbol deciding unit.

6. The apparatus according to claim 3, wherein the candidate symbol vector detecting unit performs a QR decomposition based symbol detection with minimum mean square error (MMSE) criterion on each of the Nc candidate symbols determined in the candidate symbol deciding unit.

7. The apparatus according to claim 1, wherein the final symbol vector deciding unit performs a maximum likelihood (ML) test on each of the Nc candidate transmit symbol vectors for deciding the optimized transmit symbol vector.

8. A method of detecting a symbol in a space division multiplexing (SDM) system, the method comprising:
detecting a first symbol from a receive signal vector by performing a QR decomposition on the channel matrix H;
deciding the detected first symbol and Nc−1 candidate symbols adjacent to the detected first symbol on a constellation as candidate symbols, wherein the Nc is an positive integer number;
detecting Nc candidate transmit symbol vectors from the decided Nc candidate symbols as candidate symbol vectors; and
deciding an optimized transmit symbol vector among the Nc candidate transmit symbol vector.

9. The method according to claim 8, wherein in the detecting the first symbol, the first symbol is detected by performing a sorted QR decomposition (SQRD) on the channel matrix.

10. The method according to claim 8, wherein in the detecting the candidate symbol vectors, the Nc candidate symbol vectors are detected from the Nc candidate symbols in parallel.

11. The method according to claim 10, wherein in the deciding the candidate symbol vectors, a symbol detection is orderly performed on each of the Nc candidate symbols for detecting the Nc candidate transmit symbol vectors.

12. The method according to claim 10, wherein in the deciding the candidate symbol vectors, a QR decomposition based symbol detection is performed on each of the Nc candidate symbols for detecting the Nc candidate transmit vectors.

13. The method according to claim 10, wherein in the deciding the candidate symbol vectors, remained symbol vectors are detected from a receive signal vector according to a sorted QR decomposition based symbol detection by using the detected first transmit symbol vector.

14. The method according to claim 10, wherein in the detecting the candidate symbol vectors, a QR decomposition based symbol detection with minimum mean square error (MMSE) criterion is performed on each of the Nc candidate symbols.

15. The method according to claim 8, wherein in the deciding the transmit symbol vector, a minimum likelihood (ML) test is performed on the Nc candidate transmit symbol vectors for deciding the optimized transmit symbol vector.
